(19) United States
(12) Patent Application Publication
(10) Pub. No.: US 2010/0231878 A1
(43) Pub. Date: Sep. 16, 2010

(54) Systems and methods for manufacturing semiconductor device

(76) Inventors: Hyesoo Shin, Seoul (KR); Jiyong You, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/659,506

(22) Filed: Mar. 11, 2010

(30) Foreign Application Priority Data
Mar. 13, 2009 (KR) 10-2009-0021738

(51) Int. Cl. G03B 27/54

(52) U.S. Cl. 355/67

(57) ABSTRACT

A method of manufacturing a semiconductor device includes preparing a reticle having at least three mask registration keys on respective four sides of a key field, aligning the reticle by irradiating light, after mounting the reticle on an exposure system, and measuring a mask registration including a non-linear term of the reticle from the mask registration keys using the irradiated light.

### BACKGROUND

1. Field

Example embodiments relate to systems and methods for manufacturing a semiconductor device, and more particularly, to systems and methods for manufacturing a semiconductor device using a reticle.

2. Description of the Related Art

Generally, an exposure facility is used in a photolithography process, which is one of the processes for manufacturing a semiconductor device. An exposure facility projects a circuit pattern corresponding to respective layers of an integrated circuit (IC) onto a wafer through a reticle, i.e., a mask, to form the circuit pattern on the wafer. The exposure facility may project a pattern image of the reticle onto a target region, i.e., a field region, of a wafer coated with a layer of photo sensitive material, e.g., photoresist, to form the reticle.

Conventionally, a plurality of target regions, each of which is formed to be one semiconductor chip, may be formed to be adjacent to one another on a wafer. Pattern images of reticles may be successively projected onto the target regions by various processes.

There are two kinds of exposure facilities generally used. One is a stepper and the other is a scanner. A stepper is an exposure facility which can form all the patterns by exposing the target region one time. A scanner (or a step and scan facility) is an exposure facility which exposes the target region to form a pattern by gradually scanning a projection beam into a pattern of a reticle in any one direction and by driving a wafer stage in the same direction as the scanning direction or in an opposite direction to the scanning direction.

When a plurality of pattern layers is stacked on the target regions of a wafer, formation of a new layer on an existing layer may require a process which is identical to the prior process or different from the prior process. Therefore, an overlay of each layer should be very precisely managed to manufacture a precise semiconductor device. Moreover, when a semiconductor device includes several tens of pattern layers, an overlay management is more precisely required.

Also, as a pattern size of a semiconductor device decreases, an overlap margin between layers may also be reduced. Accordingly, when manufacturing a reticle, a mask registration error, i.e., a deformation or misalignment degree of a reticle pattern with respect to a consecutive reticle pattern, should also be reduced. Although a mask registration error may be within a management limit in one reticle, when reticles are manufactured in different facilities, a difference between mask registrations of the reticles may occur. Also, when reticles are manufactured in the same facility, a mismatch between mask registrations of the reticles used in consecutive processes, e.g., prior and subsequent processes, may occur. Thus, a mismatch degree of mask registration of reticles may be amplified.

The mismatch between mask registrations of reticles may affect an interlayer overlay management on a wafer, thereby causing a misalignment between a real pattern and an overlay key measurement result on a wafer. The misalignment between the real pattern and the overlay key measurement result on the wafer may cause a fault of a semiconductor device.

### SUMMARY

Embodiments are therefore directed to systems and methods for manufacturing a semiconductor device using a reticle, which substantially overcome one or more of the problems due to the limitations and disadvantages of the related art.

Embodiments may be realized by providing a method of manufacturing a semiconductor device. The method may include preparing a reticle having at least three mask registration keys on respective four sides of a key field, aligning the reticle by irradiating a light after mounting the reticle on an exposure system, and measuring a mask registration including a non-linear term of the reticle from the mask registration keys using the irradiated light.

The method may further include correcting the measured mask registration. Correcting the measured mask registration may include calculating a misalignment degree of the measured mask registration and a mismatch degree between a mask registration of a reticle used in a prior process and the measured mask registration, and then correcting the calculated misalignment and mismatch degrees. Calculating and correcting the misalignment degree and the mismatch degree may include calculating a non-linear term and additional six terms, the additional six terms being an x-direction translation, a y-direction translation, a rotation, a magnification, an asymmetric rotation, and an asymmetric magnification, and correcting the calculated terms. The method may further include storing the corrected mask registration. The method may further include exposing a wafer using the corrected mask registration. The mask registration keys may include reticle alignment keys on the key field of the reticle to align the reticle. The reticle may further include reticle alignment keys in the key field of the reticle, the mask registration keys being different from the reticle alignment keys.

Embodiments may also be realized by providing a system for manufacturing a semiconductor device. The system may include a reticle having at least three mask registration keys on respective four sides of a key field, an exposure system for exposing a wafer using the reticle, a light source irradiating a light for measuring a mask registration of the reticle while aligning the reticle with the exposure system, and a correction portion for correcting the measured mask registration including a measured non-linear term.

The correction portion may be configured to calculate a misalignment degree of the measured mask registration and a mismatch degree between a mask registration of a reticle used in a prior process and the measured mask registration, and then to correct the misalignment and the mismatch. The calculated misalignment and the mismatch may include a non-linear term and additional six terms, the additional six terms being an x-direction translation, a y-direction translation, a rotation, a magnification, an asymmetric rotation, and an asymmetric magnification. The correction portion may be configured to store the corrected mask registration. The corrected mask registration may be configured to expose the wafer. The mask registration keys may include reticle alignment keys on the key field of the reticle to align the reticle. The reticle may further include reticle alignment keys in the key field of the reticle, the mask registration keys being different from the reticle alignment keys

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic top plan view of a mismatch degree of a mask registration between reticles used in consecutive processes;

FIG. 2 illustrates a schematic top plan view of a difference between an overlay key measurement result and a mask registration key measurement result;

FIG. 3 illustrates a top plan view of a reticle in accordance with an example embodiment; and

FIGS. 4A through 4C illustrate stages in a process of manufacturing a semiconductor device using a system for manufacturing a semiconductor device in accordance with an example embodiment.

### DETAILED DESCRIPTION

Korean Patent Application No. 10-2009-0021738, filed on Mar. 13, 2009, in the Korean Intellectual Property Office, and entitled: “Systems and Methods for Manufacturing Semiconductor Device,” is incorporated by reference herein in its entirety.

Preferred embodiments will be described below in more detail with reference to the accompanying drawings. The embodiments may, however, be embodied in different forms and should not be constructed as limited to the embodiments set forth herein. Rather, these embodiments are provided so that this disclosure will be thorough and complete, and will fully convey the scope of the inventive concept to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present.

Embodiments of the invention now will be described with reference to the accompanying drawings, in which like reference symbols refer to like elements throughout. In addition, elements illustrated in the drawings are not necessarily drawn to scale. For example, the sizes and relative sizes of layers and regions may be exaggerated. In addition, although a plurality of the same element may be shown in a drawing, only one of each element will generally be described herein for convenience of description.

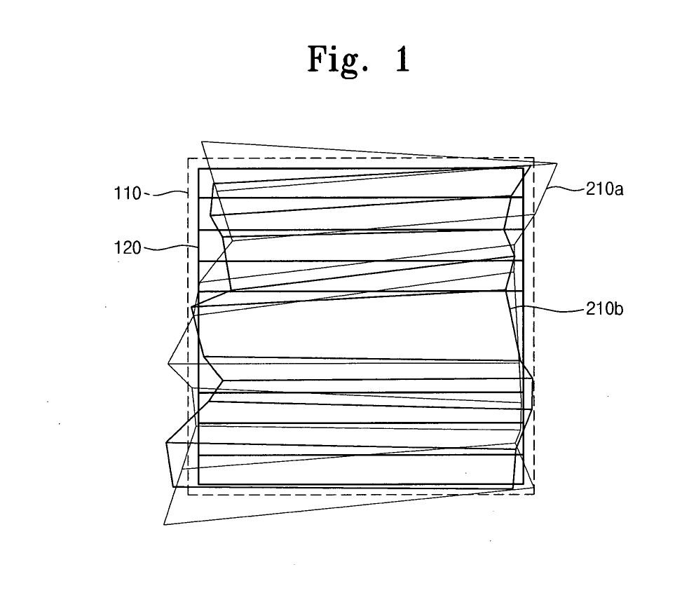

FIG. 1 illustrates a schematic top plan view of a mismatch degree of mask registrations between reticles used in consecutive processes.

Referring to FIG. 1, a field region 110 may correspond to an image field of a reticle or a field region of a wafer, e.g., a target region on a wafer for forming a pattern, and a pattern image 120 in the field region 110 may correspond to a pattern designed by a user to be applied to the field region 110 of the wafer in a photolithography process. Reference numerals 210a and 210b represent a mask registration 210a of a first reticle and a mask registration 210b of a second reticle used in two consecutive processes, e.g., respective prior and subsequent processes, in the field region 110.

Even if a respective mask registration error, i.e., a mask misalignment, of each of the mask registrations 210a and 210b relative to a respective reticle is within a management limit, it may be difficult to manage a difference of mask registration errors between the mask registrations 210a and 210b when used in consecutive processes in the field region 110. A mismatch degree of the mask registrations 210a and 210b of the first and second reticles may increase as a number of process steps increases.

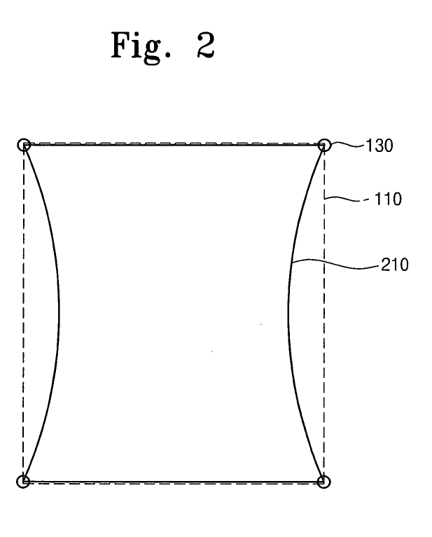

FIG. 2 illustrates a schematic top plan view of a difference between an overlay key measurement result and a mask registration key measurement result.

Referring to FIG. 2, an overlay key alignment in a photolithography process may correspond to an alignment state of a reticle with respect to the field region 110 of a wafer. For example, an overlay key alignment result 130 shows that the alignment state of the reticle with respect to the field region 110 is good. A mask registration key is used to qualify the reticle position, e.g., accuracy based on contour, with respect to the field region 110. For example, a mask registration key measurement result 210 shows that the alignment state of the reticle with respect to the field region 110 is different according to a position within the field region 110.

Due to a difference between the overlay key measurement result 130 and the mask registration key measurement result 210, a superimposition degree of a real pattern formed in the field region 110 of the wafer and a pattern formed under the real pattern may be different according to a location within the field region 110. That is, the overlay key measurement result 130 shows that the reticle is aligned with the field region 110, e.g., aligned corners, but the mask registration key measurement result 210 shows that the reticle is not aligned with the field region 110 by a mask registration error of the reticle, e.g., a contour is not aligned. Thus, it may be required to measure a mask registration of the reticle and correct the mask registration error.

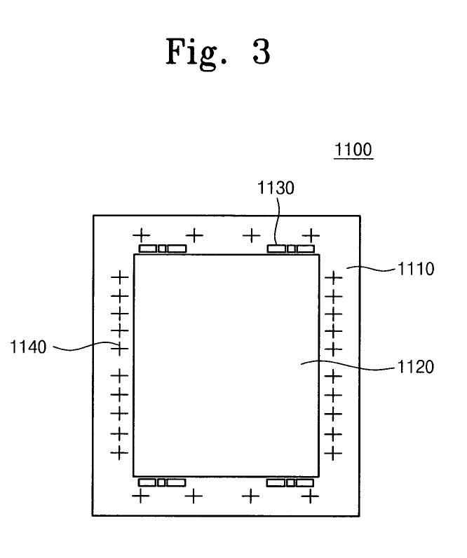

FIG. 3 illustrates a top plan view of a reticle in accordance with an example embodiment.

Referring to FIG. 3, a reticle 1100 may include a key field 1110 and an image field 1120. For example, the pattern image 120 (FIG. 1) may be provided to the image field 1120 of the reticle 1100. Reticle alignment keys 1130 and mask registration keys 1140 may be provided to the key field 1110.

The reticle alignment keys 1130 may be predetermined marks for aligning the reticle 110 with an exposure system. For example, as illustrated in FIG. 3, the reticle alignment keys 1130 may include four keys, i.e., marks, on the key field 1110 of the reticle 1100. The reticle alignment keys 1130 may be adjacent to the edges of the image field 1120 of the reticle 1100, e.g., the four keys in FIG. 3 may be arranged in pairs facing each other to have two keys adjacent to the ends of two facing sides of the image field 1120.

The mask registration keys 1140 may be predetermined marks for measuring a mask registration of the reticle 1100. The mask registration keys 1140 may have a different shape from the reticle alignment keys 1130, and may be provided in different locations than the reticle alignment keys 1130 on the key field 1110 of the reticle 1100. The mask registration keys 1140 may include at least three keys, i.e., marks, provided to respective four sides of the key field 1110 of the reticle 1100 to measure a mask registration including a non-linear term of the reticle 1100. For example, as illustrated in FIG. 3, a plurality of mask registration keys 1140 may be cross-shaped and may be arranged around the image field 1120 along four sides thereof However, the shape of the mask registration keys 1140 are not limited thereto, e.g., the mask registration keys 1140 may have a square shape, a rectangular shape, a round shape, etc.

Since the reticle 1100 has at least three mask registration keys 1140 at respective four sides of the key field 1110, the mask registration including the non-linear term of the reticle 1100 may be measured in a photolithography process.

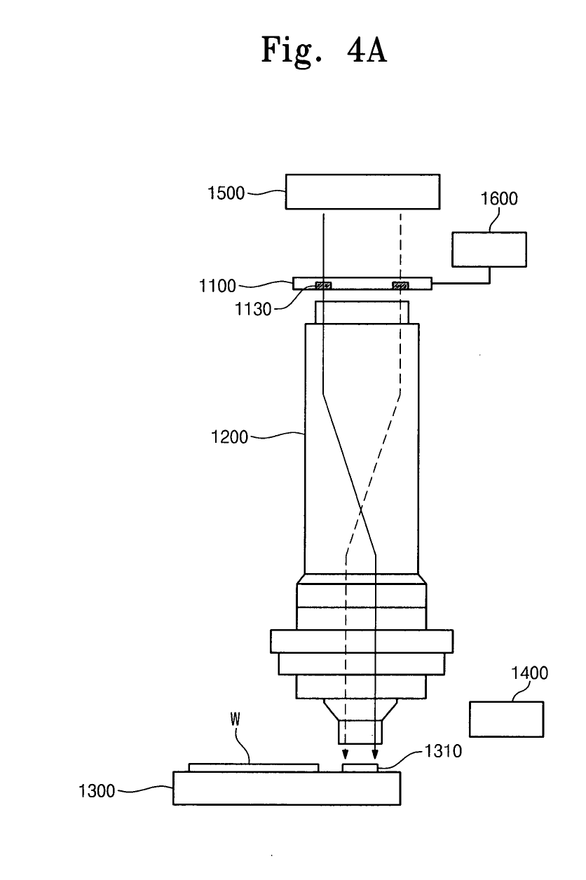

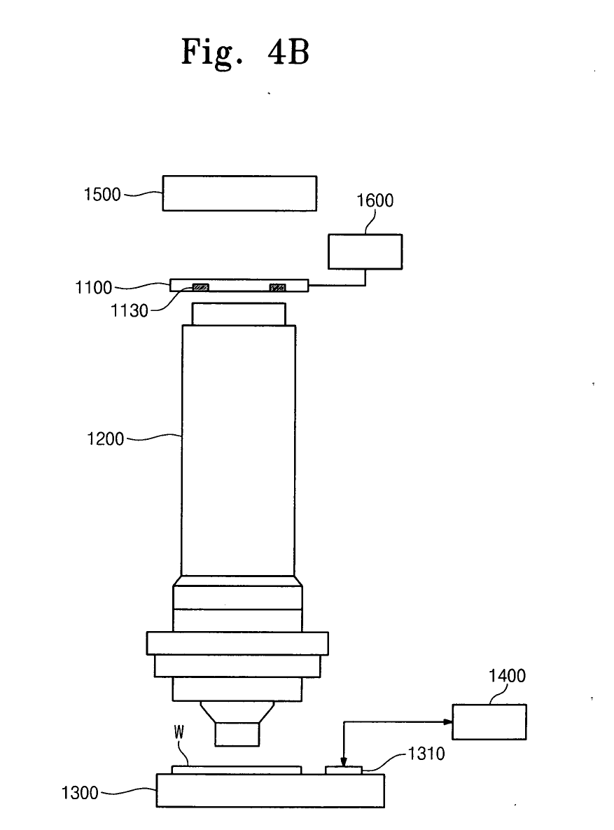

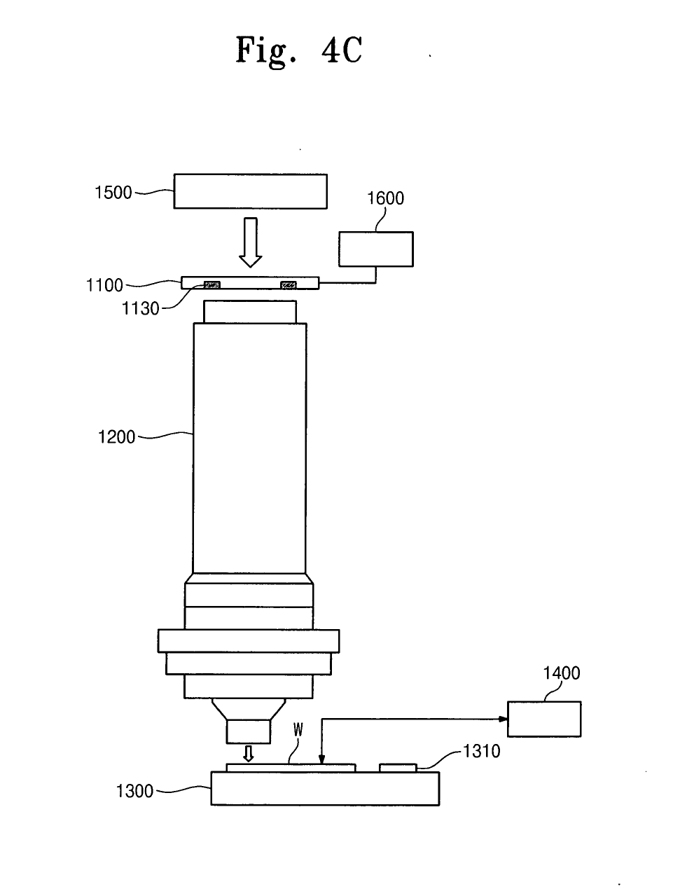

FIGS. 4A through 4C illustrate process views of a method of manufacturing a semiconductor device using a system in accordance with an example embodiment.

Referring to FIG. 4A, a system for manufacturing a semiconductor device may be an exposure system. The exposure system may include the reticle 1100, a projection optic portion 1200, a wafer stage 1300, an off-axis optical module 1400, a light source 1500, and a correction portion 1600.

The reticle 1100 may include the key field 1110 (FIG. 3) and the image field 1120 (FIG. 3). The pattern image 120 (FIG. 1) may be provided to the image field 1120 of the reticle 1100 to be applied to a wafer W on the wafer stage 1300 in a photolithography process. The plurality of reticle alignment keys 1130 and mask registration keys 1140 (FIG. 3) may be provided to the key field 1110 of the reticle 1100. The reticle alignment keys 1130 may be marks for aligning the reticle 1100 with the exposure system. The mask registration keys 1140 may include at least three keys provided to respective four sides of the key field 1110 of the reticle 1100 to measure the mask registration including a non-linear term of the reticle 1100.

The projection optic portion 1200 may perform the photolithography process by precisely aligning a pattern formed on the wafer W with a pattern image of the reticle 1100 using alignment marks, e.g., aligning an overlay key on the wafer W and the reticle alignment keys 1130 of the reticle 1100.

The wafer stage 1300 may include the wafer W, to which the pattern image of the reticle 1100 may be transferred in the photolithography process, and a fiducial mark 1310. The fiducial mark 1310 may be used to align the reticle 1100 and to control a zero position of the wafer W.

The off-axis optical module 1400 may control a zero position of the wafer W and/or may measure the overlay key on the wafer W in the photolithography process to calculate a misalignment degree between the pattern formed on the wafer W and the overlay key, and then to correct the misalignment.

The light source 1500 may align the reticle 1100 with the projection optic portion 1200 to irradiate light, i.e., indicated by a dotted line and a solid line, for measuring the mask registration of the reticle 1100 or to irradiate light, i.e., indicated by a block arrow in FIG. 4C, for transferring the pattern image of the reticle 1100 in the photolithography process.

The correction portion 1600 may store a measurement result of the mask registration of the reticle 1100, and may calculate a misalignment degree of the measured mask registration and a mismatch degree between the mask registration of a reticle used in a prior process and the measured mask registration. Further, the correction portion 1600 may correct the calculated misalignment and mismatch.

As illustrated in FIG. 4A, the reticle 1100 may be mounted in the exposure system. The reticle 1100 may be aligned with the projection optic portion 1200 using the reticle alignment keys 1130 of the reticle 1100 and the fiducial mark 1310 on the wafer state 1300, e.g., the fiducial mark 1310 may be aligned to correspond to the reticle alignment key 1130 by irradiating light to the light source 1500. At the same time, the mask registration including the non-linear term of the reticle 1100 may be measured from the mask registration keys 1140 of the reticle 1100 using light irradiated to the light source 1500.

Measuring the mask registration including the non-linear term of the reticle 1100 may include using the fiducial mark 1310 disposed on the wafer stage 1300 in the same manner as aligning the reticle 1100 with the projection optic portion 1200. Thus, the misalignment degree of the mask registration including the non-linear term of the reticle 1100 with respect to a field region of the wafer W may be known. The misalignment of the mask registration including the non-linear term of the reticle 1100 may include the non-linear term and additional six terms, i.e., an x-direction translation, a y-direction-translation, a rotation, a magnification, an asymmetric rotation, and an asymmetric magnification.

The mask registration including the non-linear term of the reticle 1100 may also be measured from the reticle alignment keys 1130 of the reticle 1100. In this case, the reticle alignment keys 1130 of the reticle 1100 may include at least three keys provided to respective four sides of the key field of the reticle 1100, as opposed to the configuration illustrated in FIG. 3. It is noted that measuring the mask registration including the non-linear term of the reticle 1100 from the reticle alignment keys 1130 of the reticle 1100 may be performed in a different manner from measuring the mask registration including the non-linear term of the reticle 1100 from the mask registration keys 1140 of the reticle 1100.

The measured mask registration may be stored in the correction portion 1600, and the correction portion 1600 may calculate, the misalignment degree of the measured mask registration with respect to the field region of the wafer W and then correct the misalignment. Thus, even when the overlay key measurement result shows a good alignment state of the reticle 1110 with respect to the field region of the wafer W, the alignment state of the reticle 1110 with respect to the field region of the wafer W may be prevented from being different according to a location within the field region of the wafer W by the mask registration error of the reticle 1110.

Also, the correction portion 1600 may calculate a mismatch degree between a storage value with respect to a mask registration of the reticle used in the prior process and the measured mask registration and then correct the mismatch. Thus, a field overlay mismatch between the reticles used in prior and subsequent processes may be minimized by effectively managing a mask registration mismatch between the reticles used in the prior and subsequent processes.

Referring to FIG. 4B, after the reticle 1100 is aligned with the projection optic portion 1200 and the mask registration of the reticle 1100 is corrected, a zero position control of the wafer W may be performed using the off-axis optical module 1400. Performing the zero position control of the wafer W refers to aligning the projection optic portion 1200 with a beginning location of the photolithography process with respect to the wafer W using the off-axis optical module 1400 and the fiducial mark 1310 provided on the wafer stage 1300.

Referring to FIG. 4C, the pattern image of the reticle 1100 may be transferred through the projection optic portion 1200 using light radiated from the light source 1500 to perform the photolithography process. At this time, after the off-axis optical module 1400 measures the alignment key on the wafer W in the photolithography process to correct a distortion of the pattern formed on the wafer W and expose the pattern image, the off-axis optical module 1400 may calculate an error degree between the pattern formed on the wafer W and the transferred image of the reticle 1110 and correct the error.

Accordingly, in the photolithography process according to embodiments, a mask registration error including the non-linear term of the reticle 1100 may be minimized, and a field overlay mismatch between the reticles used in consecutive processes may be reduced. The mask registration error of the reticle 1110 and the field overlay mismatch between the reticles used in consecutive processes may be minimized by measuring and correcting the mask registration including the non-linear term of the reticle 1110 to expose the wafer W. Thus, a fault of a semiconductor device which can occur in a photolithography process may be prevented.

A mask registration error of a reticle and a field overlay mismatch between reticles used in consecutive processes may be minimized by performing a photolithography process with reticles having mask registration keys for measuring a mask registration including a non-linear term in accordance with an embodiment. Also, a mask registration error of a reticle and a field overlay mismatch between reticles used in consecutive processes may be minimized by performing a photolithography process measuring and correcting a mask registration error including a non-linear term using a manufacturing system in accordance with an embodiment to expose a wafer W. In addition, a mask registration error of a reticle and a field overlay mismatch between reticles used in consecutive processes may be minimized by performing a photolithography process measuring and correcting a mask registration error including a non-linear term using a manufacturing method in accordance with an embodiment to expose a wafer W.

Thus, a fault of a semiconductor device that may occur in a photolithography process may be prevented or substantially minimized, thereby providing a semiconductor device having high reliability and a manufacturing method with an improved manufacturing yield. In particular, the system and method for manufacturing semiconductor devices according to an embodiment may reduce time and costs, e.g., as compared with a conventional method, since after comparing a real pattern exposed and formed in a photolithography process with an overlay key measurement result, the compared result may be corrected and an exposure process may be performed again.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1-8. (canceled)

9. A system of manufacturing a semiconductor device, comprising:
a reticle having at least three mask registration keys on respective four sides of a key field;
an exposure system configured to expose a wafer using the reticle;
a light source configured to irradiate light for measuring a mask registration of the reticle while aligning the reticle with the exposure system; and
a correction portion configured to correct the measured mask registration including a measured non-linear term.

10. The system as claimed in claim 9, wherein the correction portion is configured to calculate a misalignment degree of the measured mask registration and a mismatch degree between a mask registration of a reticle used in a prior process and the measured mask registration, and then to correct the misalignment and the mismatch.

11. The system as claimed in claim 10, wherein the calculated misalignment and the mismatch include a non-linear term and additional six terms, the additional six terms being an x-direction translation, a y-direction translation, a rotation, a magnification, an asymmetric rotation, and an asymmetric magnification.

12. The system as claimed in claim 9, wherein the correction portion is configured to store the corrected mask registration.

13. The system as claimed in claim 9, wherein the corrected mask registration is configured to expose the wafer.

14. The system as claimed in claim 9, wherein the mask registration keys include reticle alignment keys on the key field of the reticle to align the reticle.

15. The system as claimed in claim 9, wherein the reticle further comprises reticle alignment keys in the key field of the reticle, the mask registration keys being different from the reticle alignment keys.
